(19) United States
(12) Patent Application Publication
(10) Pub. No.: US 2025/0251485 A1
(43) Pub. Date: Aug. 7, 2025

(54) Pressure Sensor for Three-Dimensional Localization

(71) Applicant: Apple Inc., Cupertino, CA (US)

(72) Inventors: Gregory B. ARNDT, San Jose, CA (US); David MACNEIL, San Mateo, CA (US); Richard T. VAUGHAN, Saratoga, CA (US); Robert PREISSL, San Mateo, CA (US)

(21) Appl. No.: 18/587,763

(22) Filed: Feb. 26, 2024

Related U.S. Application Data
(60) Provisional application No. 63/452,123, filed on Mar. 14, 2023.

(51) Int. Cl. G01S 5/02; G01S 5/14

(52) U.S. Cl. CPC G01S 5/02585; G01S 5/14; G01S 2205/02

(57) ABSTRACT

An apparatus of the subject technology includes a first device in radio frequency communication with a plurality of second devices. The first device includes a transducer and a processor. The transducer measures an elevation of the first device with respect to a device of the second devices. The processor determines possible values of a three-dimensional (3D) position of the first device and selects one of the possible values as the 3D position of the first device based at least on the measured elevation.

### CROSS-REFERENCE TO RELATED APPLICATION(S)

This application claims the benefit of U.S. Provisional Application Ser. No. 63/452,123, entitled “PRESSURE SENSOR FOR 3-D LOCALIZATION,” and filed on Mar. 14, 2023, the disclosure of which is expressly incorporated by reference herein in its entirety.

### TECHNICAL FIELD

The present description relates generally to electronic devices, for example, to an electronic device with pressure sensor for three-dimensional localization.

### BACKGROUND

Electronic devices, including mobile communication devices such as smartphones and smartwatches include transducers, for example, pressure sensors for measuring elevation. Mathematical algorithms, such as trilateration or triangulation can be used to find a two-dimensional position of a communication device. For example, a global positioning system can find a location of a mobile communication device by using satellite data to determine distances between the device and three satellites. This can be enhanced by triangulation nearby, cell tower, scanning the surroundings for Wi-Fi networks, Bluetooth networks and beacon.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 is a high-level diagram illustrating an example of an environment within which certain aspects of the subject technology are implemented.

FIG. 2 is a diagram illustrating an example of a three-dimensional localization scheme with ambiguity using three spheres.

FIGS. 3A, 3B and 3C are a flow diagram illustrating an example of a process for disambiguating results of the 3D localization of FIG. 2 using a pressure sensor and corresponding tables, according to one or more implementations of the subject technology.

FIG. 4 is a schematic diagram illustrating an example of an electronic device within which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

In some aspects, the subject technology is directed to an electronic device having a transducer (e.g., a pressure sensor) for three-dimensional (3D) localization. In some embodiments, an apparatus of the subject technology includes a first device in RF communication (e.g., ultra-wideband communication) with three second devices. In some embodiments, the first device is a mobile communication device such as a smartphone or smartwatch and the second devices are static communication devices, such as routers (e.g., a network boundary router) or Wi-Fi extenders. The first device includes a transducer and a processor. The first device measures a 3D location once the elevation of the first device with respect to at least one of the second devices is determined and the X and Y coordinates are defined. The processor determines possible values of a 3D position of the first device and selects one of the possible values as the 3D position of the first device based at least on the measured elevation, as discussed in more detail herein.

The 3D position of a mobile communication device in a room or a building can be used to create a 3D model of the room or the building. For instance, by changing the position of the mobile communication device within the room or the building, the change in position can be achieved by, for example, moving mobile communication devices to locations with different heights (e.g., a desktop, a top of a shelf) within the room or to different floors of the building.

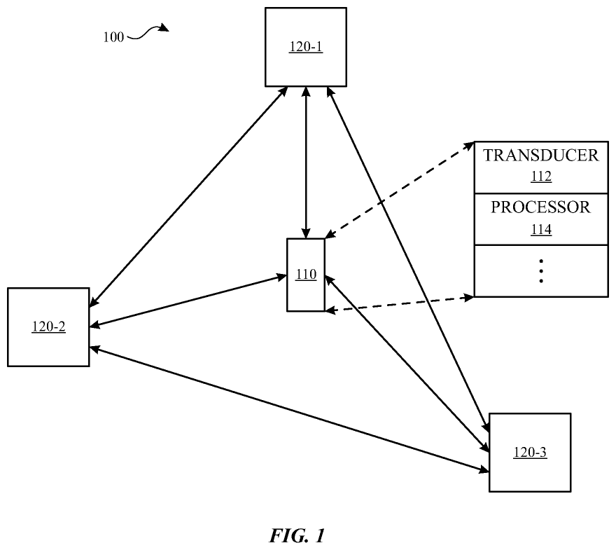

FIG. 1 is a high-level diagram illustrating an example of an environment 100 within which certain aspects of the subject technology are implemented. The environment 100 includes, but is not limited to, a first device 110 and second devices 120 (e.g., 120-1, 120-2 and 120-3). In some embodiments, the first device 110 is a mobile communication device such as a smartphone or a smartwatch. In some embodiments, the second devices 120 are static communication devices such as routers (e.g., a network boundary router) or a Wi-Fi extender. The first device 110 is in RF communication with the second devices. For example, the first device 110 and the second devices 120 can for a local network such as a Wi-Fi network or Bluetooth network.

In some embodiments, the first device 110 includes, but is not limited to, one or more transducers, for example, sensors such as gas sensors, pressure sensors or other sensors and one or more processors. A transducer 112 (e.g., a pressure sensor) of the first device 110 can measure an elevation of the first device 110 with respect to any of the second devices 120. In some embodiments, a processor 114 of the of the first device 110 can measure a distance between the first device 110 and any of the second devices 120 using the RF communication. For example, the processor 114 can send a command to a transceiver of the first device 110 to send an RF signal to the second device 120-1 and receive a respective response from the second device 120-1 and report the sending and receiving times to the processor 114. The processor 114 can use the reported sending and receiving times to obtain a time-of-flight of the RF signal between the first device 110 and the second device 120-1. The processor 114 can use the time-of-flight and the speed of light to compute a distance between the first device 110 and the second device 120-1.

According to some aspects of the subject technology, the processor can also determine possible values of a 3D position of the first device 110 and select one of the possible values as the 3D position of the first device 110, for example, in a room or a building, as described in more detail herein.

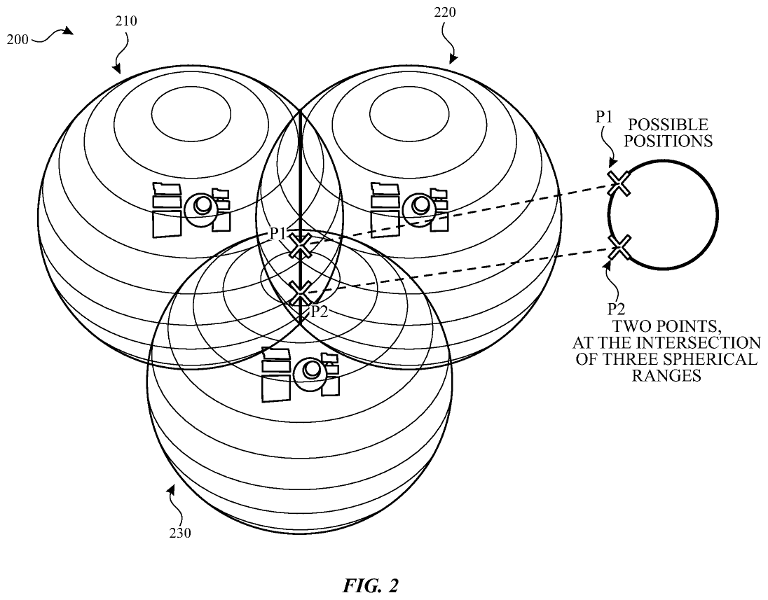

FIG. 2 is a diagram illustrating an example of 3D localization scheme 200 with ambiguity using three spheres. The 3D localization scheme uses three spheres 210, 220 and 230, the radius of each of which is equal to the distance of the first device 110 of FIG. 1 from a second device 120 of FIG. 1. In some embodiments, the processor 114 of FIG. 1 determines the radius of each of the three spheres based on the measured distance between the first device 110 and one of the second devices 120. For example, the radius of the spheres 210, 220 and 230 may be equal to the distance between the first device 110 and the second devices 120-1, 120-2 and 120-3 of FIG. 1, respectively, which are measured by using data from the transducer 112 of FIG. 1. The 3D position of the first device 110 would be represented by a point in space that is on surfaces of the spheres 210, 220 and 230. Such point would reside on the intersection of the spheres 210, 220 and 230. The intersection of the spheres 210, 220 and 230 can be mathematically calculated by the processor 114, which can determine the possible values of the 3D position of first device 110, as two points P1 (having a higher elevation value) and P2 (having a lower elevation value) located on the intersection of the three spheres, as shown in FIG. 2. The ambiguity in the 3D position due to having two solutions can be removed by the techniques of the subject technology, as described herein.

The subject disclosure uses a process to disambiguate the solution by identifying one of the points P1 or P2 as the 3D position of the first device 110. In some embodiments, the processor 114 selects the one of the possible values of the 3D position of the first device 110 (e.g., one of P1 and P2), using a measured elevation of the first device 110, as described below.

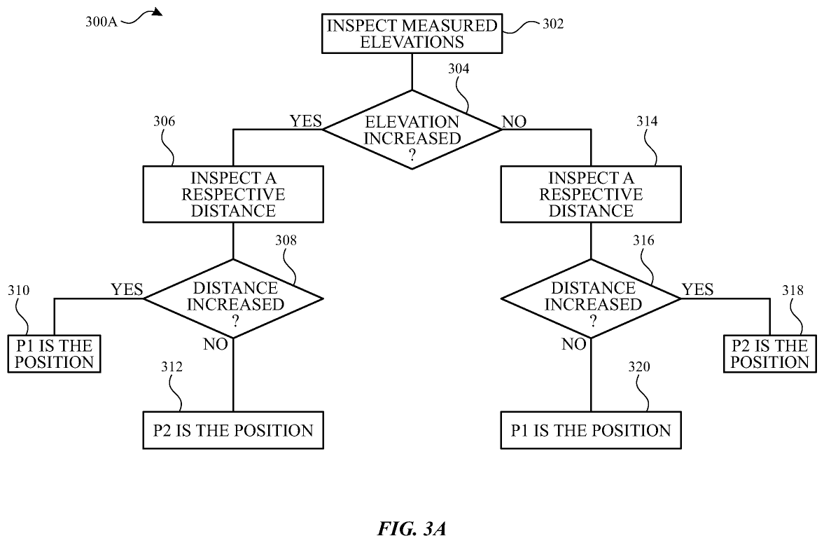

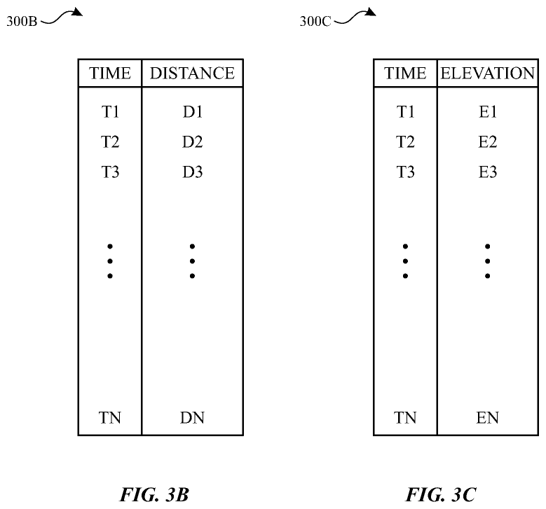

FIGS. 3A, 3B and 3C are a flow diagram illustrating an example of a process 300 for disambiguating results of the 3D localization scheme 200 of FIG. 2 using a pressure sensor and corresponding tables 300B and 300C, according to one or more implementations of the subject technology. As discussed herein, the distance between the first device 110 and any of the second devices 120 can be determined by the processor 114 of FIG. 1 using RF signals of a transceiver of the first device 110 and the respective time-of-flights, as discussed above. The processor 114 can make a table 300B of the distance data as the first device 110 is being moved around with respect to the second devices 120 (static devices) by storing distance data (d₁, d₂, d₃ . . . d_{N}) along with the corresponding time stamps (t₁, t₂, t₃ . . . t_{N}). Similarly, an elevation of the first device 110 can be determined by the processor 114 using the measured pressure data received from the transducer 112 (pressure sensor) of FIG. 1. The processor 114 can make a table 300C of the elevation data as the device 110 is being moved around by storing elevation data (E₁, E₂, E₃ . . . . E_{N}) along with the corresponding time stamps (t₁, t₂, t₃ . . . t_{N}).

The process 300 is based on the inspection of the tables of distance and elevation and their corresponding time stamps, as explained below. The processor 114 can select, for example, two measured elevation data from the elevation data and two corresponding distance data from the distance table based on the time stamps. For example, the processor 114 can select elevations E1 and E2 from the elevation table with time stamps of t1 and t2, respectively. The processor 114 can then select the respective distances D1 and D2 from the distance table by using the same time stamps of t1 and t2, respectively. The distances D1 and D2 are between the first device 110 and one of the second device 120 (e.g., 120-1).

At operation block 302, the processor 114 inspects the measured elevation data and compares, for example, E1 with E2. At operation block 304, the processor 114 determines whether the elevation increased (e.g., E2>E1). If the elevation increased, at operation block 306, the processor 114 inspect distance data and, for example, compares the distance D1 (corresponding to E1) with the distance D2 (corresponding to E2). At operation block 308, the processor 114 determines whether the distance increased (e.g., D2>D1). If the distance increased, at operation block 310, the processor 114 determines that the point P1 of FIG. 2 is the 3D position of the first device 110. Otherwise, if the distance decreased, at operation block 312, the processor 114 determines that the point P2 of FIG. 2 is the 3D position of the first device 110.

Returning to operation block 304, if the elevation decreased, at operation block 314, the processor 114 inspects distance data and compares the distance D1 with the distance D2. At operation block 316, the processor 114 determines whether the distance increased (e.g., D2>D1). If the distance increased, at operation block 318, the processor 114 determines that the point P2 is the 3D position of the first device 110. Otherwise, if the distance decreased, at operation block 320, the processor 114 determines that the point P1 is the 3D position of the first device 110.

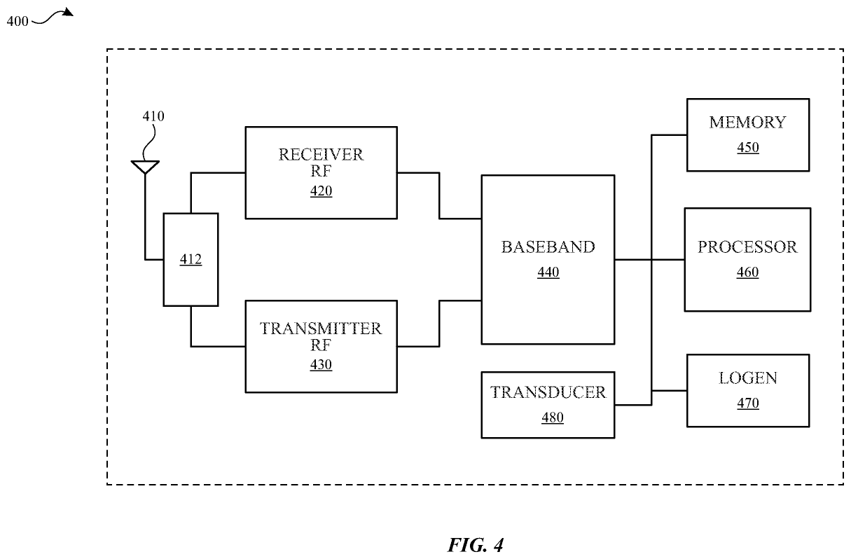

FIG. 4 is a schematic diagram illustrating an example of an electronic device 400 within which aspects of the subject technology may be implemented. In some aspects, the electronic device 400 may represent a communication device (e.g., a smartphone or smartwatch), a tablet, a laptop or any other electronic device. The electronic device 400 may comprise a radio frequency (RF) antenna 410, a receiver 420, a transmitter 430, a baseband processing module 440, a memory 450, a processor 460, a local oscillator generator (LOGEN) 470 and a transducer 480. In various embodiments of the subject technology, one or more of the blocks represented in FIG. 4 may be integrated on one or more semiconductor substrates. The blocks 420-470, for example, may be realized on a single chip, a single system on a chip or on a multi-chip chipset.

The RF antenna 410 may be suitable for transmitting and/or receiving RF signals (e.g., wireless signals) over a wide range of frequencies. Although a single RF antenna 410 is illustrated, the subject technology is not so limited.

The receiver 420 may comprise suitable logic circuitry and/or code that may be operable to receive and process signals from the RF antenna 410. The receiver 420 may, for example, be operable to amplify and/or down-convert received wireless signals. In various embodiments of the subject technology, the receiver 420 may be operable to cancel noise in received signals and may be linear over a wide range of frequencies. In this manner, the receiver 420 may be suitable for receiving signals in accordance with a variety of wireless standards, including Wi-Fi, WiMAX, Bluetooth and other various cellular standards. In various embodiments of the subject technology, the receiver 420 may not require any SAW filters and few or no off-chip discrete components, such as large capacitors and inductors.

The transmitter 430 may comprise suitable logic circuitry and/or code that may be operable to process and transmit signals from the RF antenna 410. The transmitter 430 may, for example, be operable to up-convert baseband signals to RF signals and amplify RF signals. In various embodiments of the subject technology, the transmitter 430 may be operable to up-convert and amplify baseband signals processed in accordance with a variety of wireless standards. Examples of such standards may include Wi-Fi, WiMAX, Bluetooth and other various cellular standards. In various embodiments of the subject technology, the transmitter 430 may be operable to provide signals for further amplification by one or more power amplifiers.

The duplexer 412 may provide isolation in the transmit band to avoid saturation of the receiver 420, damaging parts of the receiver 420 and/or to relax one or more design requirements of the receiver 420. Furthermore, the duplexer 412 may attenuate the noise in the receive band. The duplexer may be operable in multiple frequency bands for various wireless standards.

The baseband processing module 440 may comprise suitable logic, circuitry, interfaces and/or code that may be operable to perform processing of baseband signals. The baseband processing module 440 may, for example, analyze received signals, generate control and/or feedback signals for configuring various components of the electronic device 400, such as the receiver 420. The baseband processing module 440 may be operable to encode, decode, transcode, modulate, demodulate, encrypt, decrypt, scramble, descramble and/or otherwise process data in accordance with one or more wireless standards. In some implementations, the baseband processing module 440 may include an intelligent boot circuit and perform the functionalities of the intelligent boot of the subject technology, as described above.

The processor 460 may comprise suitable logic, circuitry and/or code that may enable processing data and/or controlling operations of the electronic device 400. In this regard, the processor 460 may be enabled to provide control signals to various other portions of the electronic device 400. The processor 460 may also control transfers of data between various portions of the electronic device 400. Additionally, the processor 460 may enable the implementation of an operating system or otherwise execute code to manage the operations of the electronic device 400.

In some implementations, the processor 460 may replace or execute some or all of the functionalities of the processor 114 of FIG. 1 as described above with respect to FIGS. 1, 2 and 3. The processor 460 may use data from the receiver 420 and the transmitter 430 to determine a distance of the first device 110 from one of the second devices 120 of FIG. 1 (e.g., 120-1), as discussed above. For example, the processor 460 may use send and receive time stamps associated with an RF signal sent from the transmitter 430 to one of the second device 120-1 and the response received from the second device 120-1 by the receiver 420 to perform the time-of-flight calculation, as explained above. For example, the processor 460 may store distance data, measured as the first device 110 moves around, in the memory 450 in the form of a distance table along with corresponding time stamps.

In some implementations, the processor 460 may use data (e.g., the pressure data) from the transducer 480 (e.g., a pressure sensor) to measure the elevation of the first device 110 as it moves around and to store the elevation data in the memory 450 in the form of an elevation table along with corresponding time stamps.

The memory 450 may comprise suitable logic, circuitry and/or code that may enable the storage of various types of information, such as received data, generated data, code and/or configuration information. The memory 450 may comprise, for example, RAM, ROM, flash and/or magnetic storage. In various embodiments of the subject technology, information stored in the memory 450 may be utilized for configuring the receiver 420 and/or the baseband processing module 440.

The local oscillator generator (LOGEN) 470 may comprise suitable logic, circuitry, interfaces and/or code that may be operable to generate one or more oscillating signals of one or more frequencies. The LOGEN 470 may be operable to generate digital and/or analog signals. In this manner, the LOGEN 470 may be operable to generate one or more clock signals and/or sinusoidal signals. Characteristics of the oscillating signals, such as the frequency and the duty cycle, may be determined based on one or more control signals from, for example, the processor 460 and/or the baseband processing module 440.

In operation, the processor 460 may configure the various components of the electronic device 400 based on a wireless standard according to which it is desired to receive signals. Wireless signals may be received via the RF antenna 410 and amplified and down converted by the receiver 420. The baseband processing module 440 may perform noise estimation and/or noise cancellation, decoding and/or demodulation of the baseband signals. In this manner, information in the received signal may be recovered and utilized appropriately. For example, the information may be audio and/or video to be presented to a user of the electronic device, data to be stored in the memory 450 and/or information affecting and/or enabling the operation of the electronic device 400. The baseband processing module 440 may modulate, encode and perform other processing on audio, video and/or control signals to be transmitted by the transmitter 430 in accordance with various wireless standards.

In some implementations, the transducer 480 may be a pressure sensor that can be used for 3D localization, for example, in a closed environment such as a home or office. In some embodiments, the pressure sensor can be used to generate a 3D model of a room or an entire building such as a house.

As used herein, the phrase “at least one of” preceding a series of items, with the terms “and” or “or” to separate any of the items, modifies the list as a whole rather than each member of the list (i.e., each item). The phrase “at least one of” does not require selection of at least one of each item listed; rather, the phrase allows a meaning that includes at least one of any one of the items and/or at least one of any combination of the items and/or at least one of each of the items. By way of example, the phrases “at least one of A, B and C,” or “at least one of A, B or C” each refer to only A, only B or only C; any combination of A, B and C; and/or at least one of each of A, B and C.

The predicate words “configured to,” “operable to” and “programmed to” do not imply any particular tangible or intangible modification of a subject, but rather are intended to be used interchangeably. In one or more implementations, a processor configured to monitor and control an operation or a component, may also mean the processor being programmed to monitor and control the operation or the processor, being operable to monitor and control the operation. Likewise, a processor configured to execute code can be construed as a processor programmed to execute code or operable to execute code.

Phrases such as “an aspect,” “the aspect,” “another aspect,” “some aspects,” “one or more aspects,” “an implementation,” “the implementation,” “another implementation,” “some implementations,” “one or more implementations,” “an embodiment,” “the embodiment,” “another embodiment,” “a configuration,” “the configuration,” “another configuration,” “some configurations,” “one or more configurations,” “the subject technology,” “the disclosure,” “the present disclosure” or any other variations thereof and alike are for convenience and do not imply that a disclosure relating to such phrase(s) is essential to the subject technology or that such disclosure applies to all configurations of the subject technology. A disclosure relating to such phrase(s) may apply to all configurations or to one or more configurations. A disclosure relating to such phrase(s) may provide one or more examples. A phrase such as “an aspect” or “some aspects,” may refer to one or more aspects and vice versa and this applies similarly to other foregoing phrases.

The word “exemplary” is used herein to mean “serving as an example, instance or illustration.” Any embodiment described herein as “exemplary” or as an “example” is not necessarily to be construed as preferred or advantageous over other implementations. Furthermore, to the extent that the terms “include,” “have” or the like are used in the description or the claims, such terms are intended to be inclusive in a manner similar to the term “comprise,” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public, regardless of whether such disclosure is explicitly recited in the claims. No claim element is to be construed under the provisions of 35 U.S.C. § 112 (f) unless the element is expressly recited using the phrase, “means for,” or, in the case of a method claim, the element is recited using the phrase, “step for.”

The previous description is provided to enable any person skilled in the art to practice the various aspects described herein. Various modifications to these aspects will be readily apparent to those skilled in the art and the generic principles defined herein may be applied to other aspects. Thus, the claims are not intended to be limited to the aspects shown herein but are to be accorded the full scope consistent with the language claims, wherein reference to an element in the singular is not intended to mean, “one and only one,” unless specifically so stated, but rather, “one or more.” Unless specifically stated otherwise, the term “some” refers to one or more. Pronouns in the masculine (e.g., his) include the feminine and neutral genders (e.g., her and its) and vice versa. Headings and subheadings, if any, are used for convenience only and do not limit the subject disclosure.

What is claimed is:

1. An apparatus, comprising:
a first device in radio frequency (RF) communication with a plurality of second devices wherein:
the first device includes a transducer and a processor,
the transducer is configured to measure an elevation of the first device with respect to a device of the plurality of second devices, and
the processor is configured to:
determine possible values of a three-dimensional (3D) position of the first device, and
select one of the possible values as the 3D position of the first device based on the measured elevation.

2. The apparatus of claim 1, wherein the processor is configured to determine the possible values as two points located on a mathematically calculated intersection of three spheres.

3. The apparatus of claim 2, wherein the processor is configured to determine a radius of each of the three spheres based on a measured distance between the first device and one of the plurality of second devices.

4. The apparatus of claim 1, wherein the first device comprises a mobile communication device including a smartphone or a smartwatch, and wherein the transducer comprises a pressure sensor.

5. The apparatus of claim 1, wherein the plurality of second devices comprises three static communication devices including routers or range extenders.

6. The apparatus of claim 1, wherein the processor is configured to measure a distance between the first device and the device of the plurality of second devices using the RF communication.

7. The apparatus of claim 6, wherein the processor is configured to select the one of the possible values having a higher value of the measured elevation when an increase in an elevation of the first device causes an increase in the measured distance.

8. The apparatus of claim 6, wherein the processor is configured to select the one of the possible values having a lower value of the measured elevation when an increase in an elevation of the first device causes a decrease in the measured distance.

9. The apparatus of claim 6, wherein the processor is configured to select the one of the possible values having a lower value of the measured elevation when a decrease in an elevation of the first device causes an increase in the measured distance.

10. The apparatus of claim 6, wherein the processor is configured to select the one of the possible values having a higher value of the measured elevation when a decrease in an elevation of the first device causes a decrease in the measured distance.

11. A device, comprising:
a processor;
a transceiver configured to establish radio frequency (RF) communication with a plurality of static devices; and
a transducer configured to measure an elevation of the device with respect to at least one of the plurality of static devices,
wherein:
the processor is configured to determine a 3D position of the device by:
determining two possible values of the 3D positions of the device by using a mathematically calculated intersection of three spheres; and
selecting one of the two possible values as the 3D position of the device based at least on the measured elevation.

12. The device of claim 11, wherein the processor is configured to determine a radius of each of the three spheres based on a measured distance between the device and one of the plurality of static devices.

13. The device of claim 11, wherein the processor is configured to measure a distance between the device and the at least one of the plurality of static devices using the RF communication.

14. The device of claim 13, wherein the processor is configured to select the one of the possible values having a higher value of the measured elevation when an increase in an elevation of the device causes an increase in the measured distance.

15. The device of claim 13, wherein the processor is configured to select the one of the possible values having a lower value of the measured elevation when an increase in an elevation of the device causes a decrease in the measured distance.

16. The device of claim 13, wherein the processor is configured to select the one of the possible values having a lower value of the measured elevation when a decrease in an elevation of the device causes an increase in the measured distance.

17. The device of claim 13, wherein the processor is configured to select the one of the possible values having a higher value of the measured elevation when a decrease in an elevation of the device causes a decrease in the measured distance.

18. A mobile communication device, the device comprising:
a transceiver in radio frequency (RF) communication with a plurality of static devices;
a pressure sensor configured to measure an elevation of the device with respect to at least one of the plurality of static devices based on a measured pressure; and
a processor configured to determine a three-dimensional (3D) position of the device by:
determining two possible positions of the device using a mathematically calculated intersection of three spheres; and
selecting one of the two possible values as the 3D position of the device based at least on a change of the measured distance between the device and the at least one of the plurality of static devices in response to a change in an elevation of the device.

19. The device of claim 18, wherein the processor is configured to select the one of the two possible values that corresponds to a higher elevation when an increase or decrease in the measured elevation of the device causes a respective increase or decrease in a distance between the device and the at least one of the plurality of static devices.

20. The device of claim 18, wherein the processor is configured to select the one of the two possible values that corresponds to a lower elevation when an increase or decrease in the measured elevation of the device causes a respective decrease or increase in a distance between the device and the at least one of the plurality of static devices.
